(19) United States
(12) Patent Application Publication
(10) Pub. No.: US 2010/0037720 A1
(43) Pub. Date: Feb. 18, 2010

(54) Robotic manipulator

(75) Inventor: Mark E. Rosheim, Minneapolis, MN (US)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: Rose-Hime Designs, Inc., Minneapolis, MN (US)

(21) Appl. No.: 12/583,022

(22) Filed: Aug. 13, 2009

Related U.S. Application Data
(60) Provisional application No. 61/188,986, filed on Aug. 14, 2008.

(51) Int. Cl. B25J 17/00

(52) U.S. Cl. 74/490.03; 74/490.05; 901/28

(57) ABSTRACT

A controlled relative motion system permitting a controlled motion member, joined to a base member, to selectively move with respect to the base member, has a base support, an output structure, and a fork arc structure having a pair of arc output ends with the output structure rotatably connected to a corresponding one of the pair of arc arms adjacent the arc output end thereof so as to be rotatable about an output structure rotation axis. A fork arc structure rotary support has each remaining base end of the pair of arc arms joined thereto and is rotatably connected to the base support so that said fork arc structure is rotatable about a fork axis intersecting the base plane at a selected suspension angle. An output structure force imparting means is connected between the output structure and an operating one of the pair of arc arms. A fork arc structure force imparting means is connected between the base support and the fork arc structure.

### BACKGROUND

Increasing use of precision directional electromagnetic radiation sensors sensitive in various frequency or wavelength ranges has added to the need for mechanical manipulators that can point objects, or workpieces, mounted thereon, such as those sensors, accurately and repeatedly anywhere in a desired workspace. Many kinds of these sensors must be pointable over many different circular arc ranges all exceeding 60°, and be capable of doing so at large angular position change rates. Singularities in the dynamics of such manipulators, or loss of a degree-of-freedom in the workspace, due both to conditions in the physical structure or in control software used in the control system provided therefor, often impede the performance of mechanical manipulators in reaching these goals.

Many uses of these mechanical manipulators require a highly precise but limited range of motion for the manipulator in providing various desired paintings of objects mounted thereon. One such manipulator that has been used for these purposes is provided by gimbals supporting an object for pointing such as a sensor. In the past, such pointing gimbals have had a gimbal ring arrangement driven by a pair of motors. Their use requires providing therewith flexible wiring or slip-rings, or both, to supply electrical power to the mounted object, and to provide position and rate information to at least one of the drive motors. These slip-rings, or other forms of supplying electrical power and communicating information through or around objects rotating relative to each other, often result in reliability problems due to mechanical wear, aging through corrosion, and other environmental factors.

Another performance requirement is that the mounted object such as a sensor be as isolated as possible from shock and vibration which is always present in uses of such manipulators such as when a missile in which a sensor is mounted on such a manipulator is being handled, carried on a moving platform, or propelled in flight. Typically in the past, gimbals supporting an object for pointing such as a sensor were mounted directly to structural walls in the missile and so were directly subjected to the accompanying shocks and vibrations. As a result, elaborate and costly means have been designed for gimbal mounted sensors to attempt to isolate them from such shocks and vibrations otherwise transmitted thereto by the gimbals. However, this adds to the cost and complexity of the device.

In many instances, and in particular, in airborne systems such as missiles, it is very advantageous for manipulators used for pointing sensors therein toward desired locations to be very compact. Not only do such manipulators need to be compact in mechanical extent themselves but also must manipulate the sensor mounted thereon in a very compact workspace. The sensors being manipulated may be relatively large compared to the work envelope within which they are manipulated. This necessitates a robotic manipulator that has relatively thin cross-sections when view from certain directions that together permit operation in a confined space while at the same time manipulating a relatively bulky sensor.

One reason for this compact space limiting of the sensor motion becoming critical is due to the geometry required for the missile nose cone that is necessary for it to meet its aerodynamic performance specifications. The nose cone, for example, may incorporate a hemispherical transparent lens defining much of the workspace that, as indicated above, requires the motion of the sensor to track the geometry of the interior surface of that lens so as to leave a constant small separation distance between that lens interior surface and the sensor structure and such that the sensor pointing or sensing axis is maintained in directions normal to that surface. Thus, there is a desire for an improved pointing mechanical manipulator especially for use with precise direction sensors.

### SUMMARY

The present invention provides a controlled relative motion system permitting a controlled motion member, joined to a base member, to selectively move with respect to the base member has a base support substantially extending along a base plane, an output structure, and a fork arc structure having a pair of arc output ends, each at an end of a corresponding one of a pair of arc arms, positioned across from one another with the output structure rotatably connected on opposite sides thereof to a corresponding one of the pair of arc arms adjacent the arc output end thereof so as to be rotatable about an output structure rotation axis intersecting each of the pair of arc arms adjacent the arc output end thereof. A fork arc structure rotary support has each remaining base end of the pair of arc arms, opposite the arc output end thereof, joined thereto, the fork arc structure support being rotatably connected to the base support so that said fork arc structure is rotatable about a fork axis extending substantially perpendicular to a arc structure plane that includes the output structure rotation axis and intersecting the base plane at a selected suspension angle. An output structure force imparting means is provided having a stator portion connected to a selected one of the output structure and a operating one of the pair of arc arms, and further having a rotor portion, selectively rotatable with respect to the stator portion thereof, connected to that one remaining of the output structure and the operating one of the pair of arc arms. A fork arc structure force imparting means is provided having a stator portion connected to a selected one of the base support and the fork arc structure, and further having a rotor portion, selectively rotatable with respect to the stator portion thereof, connected to that one remaining of the base support and the fork arc structure.

### BRIEF DESCRIPTION OF THE DRAWINGS

FIG. 1 is an elevated perspective view of a mechanical manipulator embodying the present invention,

FIG. 2 is another-perspective view of the manipulator shown in FIG. 1,

FIG. 3 is a bottom view of the manipulator shown in FIG. 1,

FIG. 4 is a top view of the manipulator shown in FIG. 1,

FIG. 5 is a side cross section view of the manipulator shown in FIG. 1 as indicated in FIG. 4,

FIG. 6 is another side cross section view of the manipulator shown in FIG. 1 as indicated in FIG. 4,

FIG. 7 is a frontal elevation view of the manipulator shown in FIG. 1,

FIG. 8 is an exploded view of the manipulator shown in FIG. 1,

FIG. 9 is a perspective view of a portion of the manipulator shown in FIG. 1,

FIG. 10 is a side elevation view of the manipulator shown in FIG. 7,

FIG. 11 is another side elevation view of the manipulator shown in FIG. 10,

FIG. 12 is a side cross section view of the manipulator shown in FIG. 11,

FIG. 13 is again the side elevation view of the manipulator shown in FIG. 10 repositioned,

FIG. 14 is a frontal perspective cross section view of the manipulator shown in FIG. 1 as indicated in FIG. 13,

FIG. 15 is an elevated perspective view of an alternative mechanical manipulator embodying the present invention,

FIG. 16 is again the side elevation view of the alternative manipulator shown in FIG. 15 repositioned,

FIG. 17 is a side cross section view of the manipulator shown in FIG. 16 as indicated in FIG. 16,

FIG. 18 is a frontal perspective cross section view of the manipulator shown in FIG. 16 as indicated in FIG. 16, and

FIGS. 19A and 19B are exploded views each of a different corresponding portion of the manipulator shown in FIG. 15.

### DETAILED DESCRIPTION

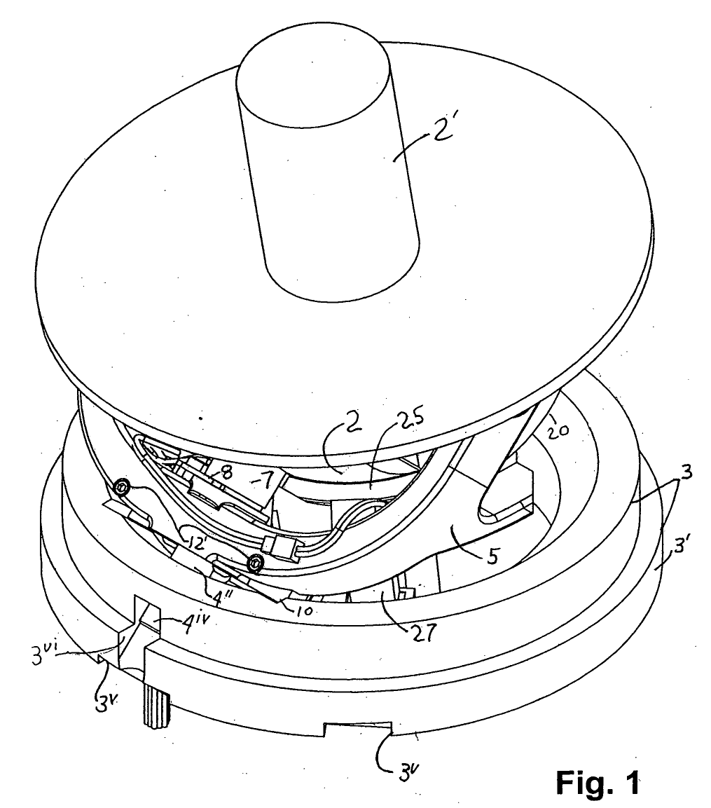

The object positioning arrangement, or manipulator, shown in the elevated perspective view of FIG. 1 allows an object or workpiece to be rotated to various pointings by that manipulator, 1, about a single center point of rotation that is coincident with the approximate center of an output structure, 2, and perhaps also of a workpiece, 2′, mounted thereon if mounted to also be within an open interior of that output structure. Thus, workpiece 2′, depending on its size, may be mounted above, across from, or even below the center point of rotation in the open interior of output structure 2. Alternatively, output structure 2 and workpiece object 2′ may be to some extent structurally integrated through having some shared structural members.

The center point of rotation is the intersection of two axes about one of which the ends of a supporting and manipulating fork arrangement is rotatably connected to output structure 2, and the other about which the fork base is rotatably connected. This configuration is particularly advantageous when manipulating workpiece object 2′, such as a sensor, which, when placed in motion by manipulator 1, must follow closely the interior surface of a lens or radome while requiring minimum lengths of wire, tubing, or fiber optic harnesses for conveying power and signals to or from that workpiece object, or both. Also, the workpiece object, again such as a sensor, may need to undergo those motions in a very compact workspace without mechanically interfering with housing or other structures positioned in the vicinity thereof.

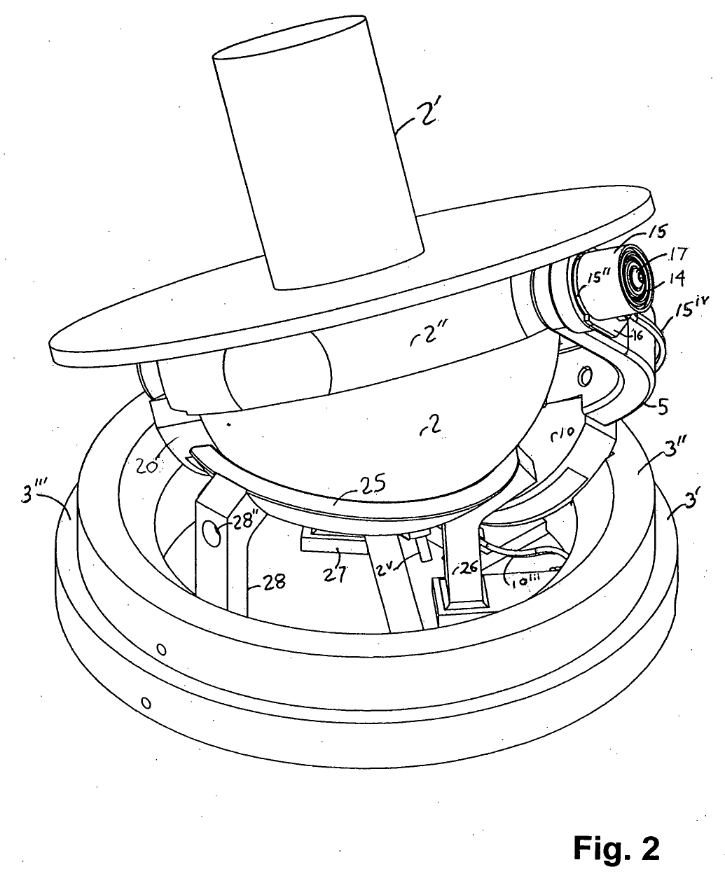

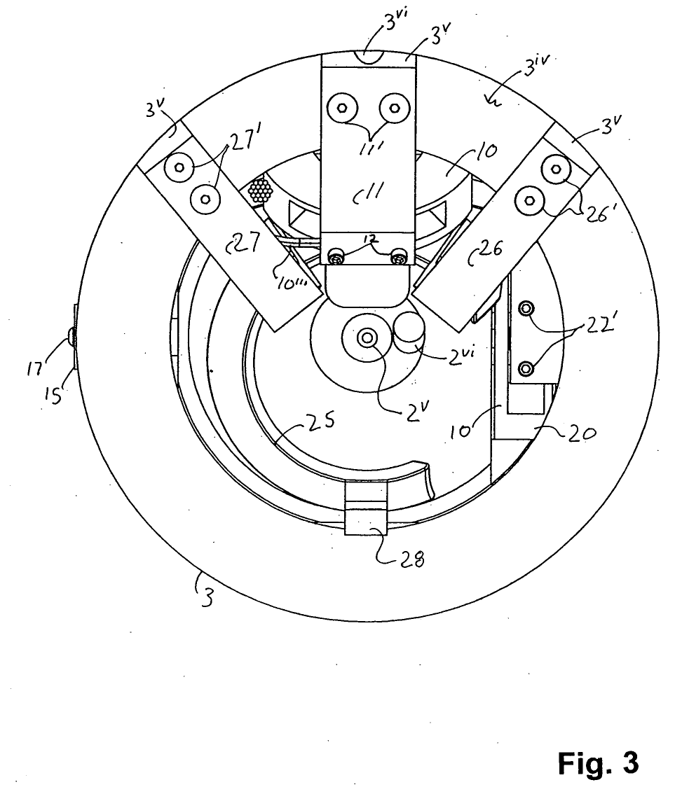

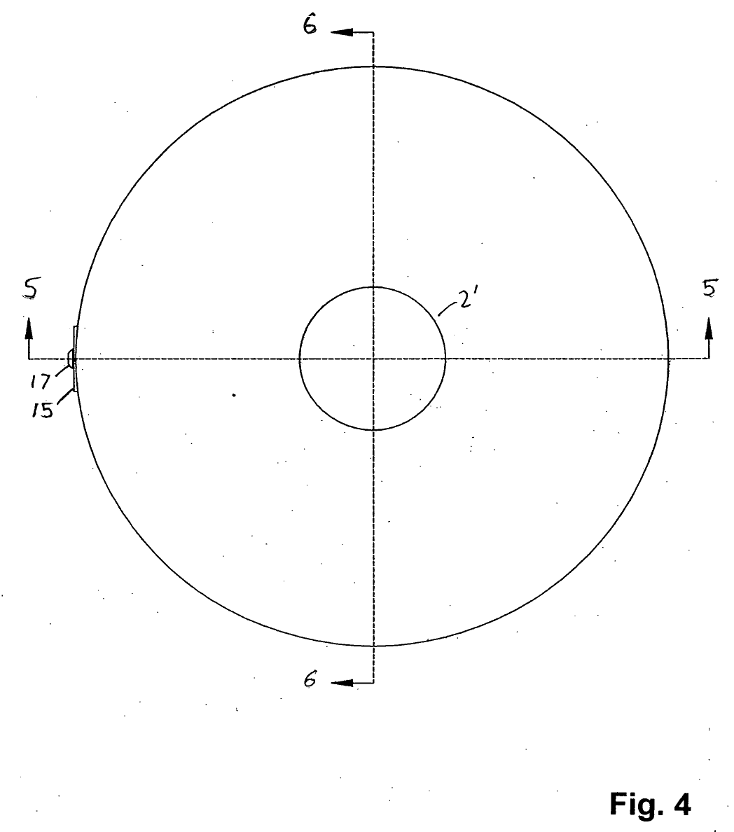

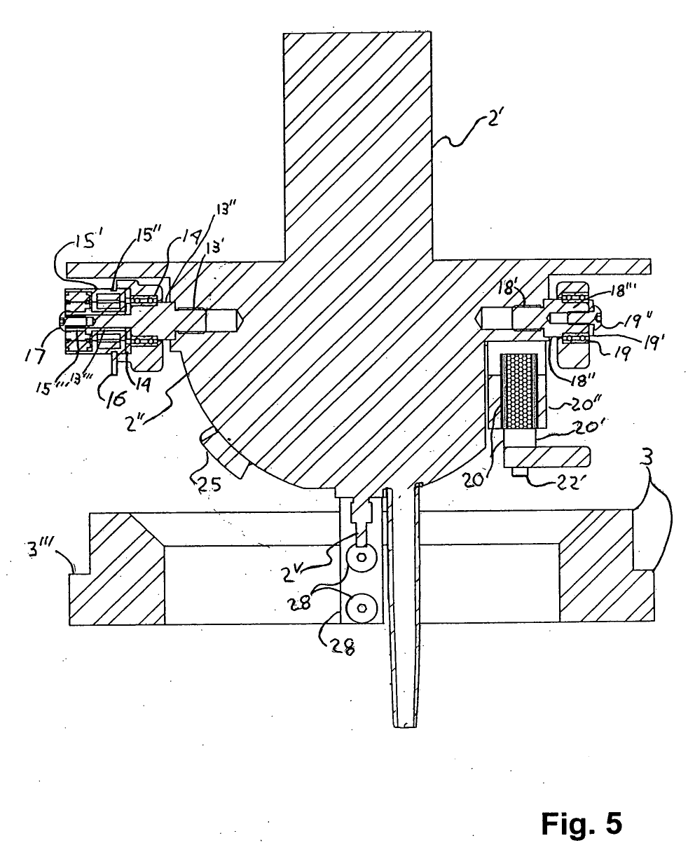

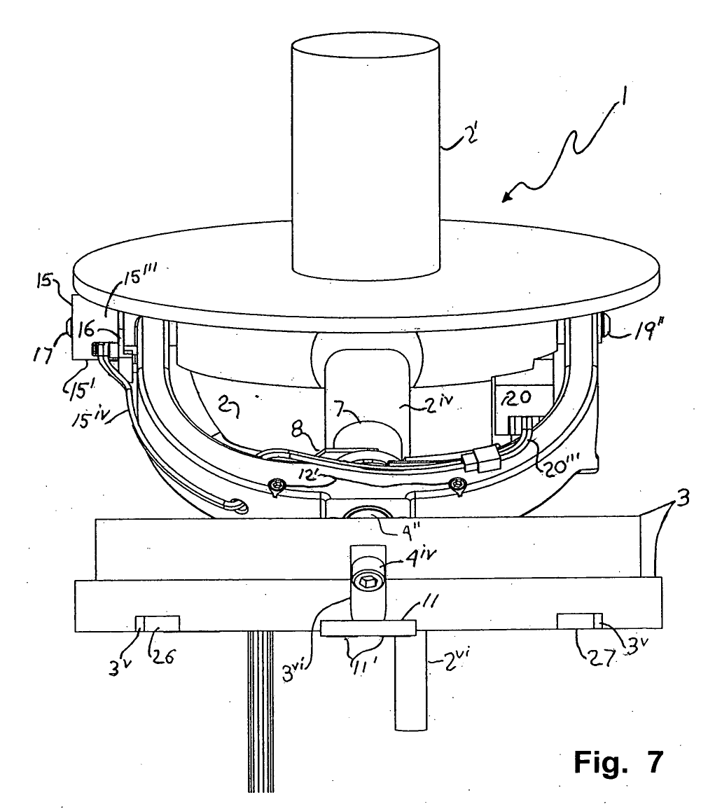

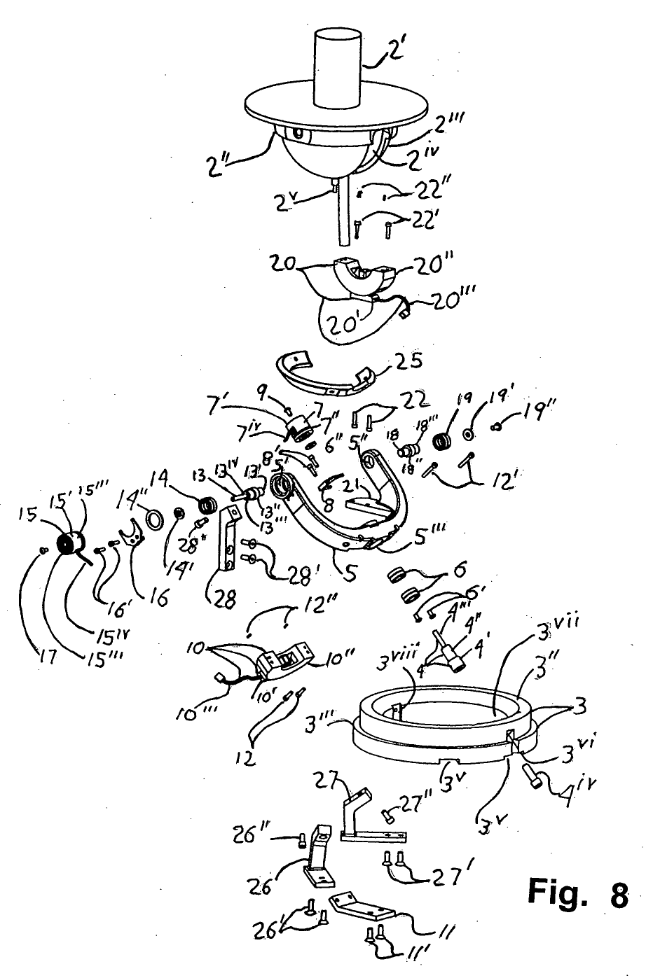

As shown in perspective views of manipulator 1 in FIGS. 1 and 2 from differing vantage points, in the bottom view thereof in FIG. 3, in the top view thereof in FIG. 4 and in the corresponding orthogonal cross section side views 5 and 6 indicated in FIG. 4, in the front elevation view of FIG. 7, and in the exploded view of FIG. 8, output structure 2 is shown to approximate a modified hemisphere, or modified hemispherical shell (so as to have an open interior). Output structure 2 has a support collar, 2″, about its generally curved side adjacent where that side perpendicularly joins to the major flat side thereof, this major flat side supporting at least in part workpiece object 2′. A minor flat side, 2′″, of output structure 2 extends perpendicularly to, but does not meet, the major flat side relatively near one edge of the major flat side by the omission of what would otherwise be a portion of the hemisphere or hemispherical shell of output structure 2 and an omission of a lower portion of support collar 2″.

In addition, a recessed relief channel, 2^{iv}, is formed in the generally curved surface of the hemisphere or hemispherical shell of output structure 2 and a lower portion of support collar 2″ that extends downward to near the central point of output structure 2 farthest from the major flat surface thereof. Finally, a coupling, 2^{v}, is shown through the wall of output structure 2 at this central point for passing a coolant to be used with workpiece object 2′, and an electrical cabling tube, 2^{vi}, is shown also through the wall of output structure 2 in which electrical power and signaling leads are to be provided as needed for workpiece object 2′ such as a sensor.

The foregoing figures further show that there is provided a base ring, 3, with an approximately cylindrically shaped open center. Base ring 3 has a lower ring portion, 3′, with an exterior side surface of a greater diameter than the exterior side surface of an upper ring portion, 3″, to thereby expose a horizontal top surface, 3′″, of the lower ring portion outside of where that ring portion is joined to the upper ring portion so as to thereby end the inward extent of surface 3′″. Horizontal top surface 3′″ of the lower ring portion, projected parallelly inward, defines the joining plane of the upper and lower ring portions, and is positioned on the opposite side of lower ring portion 3′ from a horizontal bottom surface, 3^{iv}, of this lower ring portion, and from which three plate mounting recesses, 3^{v}, extend into this lower ring portion. A mounting screw recess, 3^{vi}, extends through the exterior side surfaces of lower ring portion 3′ and upper ring portion 3″, and horizontal top surface 3′″, into these ring portions.

Lower ring portion 3′ surrounds the open center with its interior side surface having a diameter that is the same as that of the interior side surface about this open center of upper ring portion 3″ into which it merges where these two ring portions are joined together at the joining plane. However, the interior side surface about the open center of upper ring portion 3″, from a location above this joining location, is beveled outwardly at about 45° from vertical starting at that location, and from there that bevel extends to the top of that upper ring portion. The final inward circular portion of mounting screw recess 3^{vi}, with an axis of symmetry extends partly inward in a direction toward the axis of symmetry of the base ring 3 open center, and so partly along a radius of that base ring, but at an angle of about 45° with respect to a horizontal plane. This final inward circular portion emerges into a larger diameter concentric hole mounting recess, 3^{vii}. Hole mounting recess 3^{vii} extends into upper ring portion 3″ from the beveled interior surface thereof. A post mounting recess, 3^{viii}, extends through the parallel interior side surfaces of lower ring portion 3′ and upper ring portion 3″ into these ring portions.

A stack of two concentric truncated cylindrical shells on either side of a truncated cylinder, all of differing outer diameters, are joined end-to-end concentrically to thereby together form a fork base post, 4, about an axis of symmetry. One of the truncated cylindrical shells at one end of the stack, the one having the largest outer diameter, forms a post base, 4′, that is positioned in hole mounting recess 3^{vii} so as to extend through the interior beveled surface of upper ring portion 3″, and into that ring portion, at an angle of about 90° with respect to that surface. As a result, the axis of symmetry of fork base post 4 also extends partly inward in a direction toward the axis of symmetry of the open center, and so partly along a radius of base ring 3, but at an angle of about 45° with respect to a plane through horizontal top surface 3″′ of lower ring portion 3′. This is not the only angle that could be chosen for fork base post 4 but is a reasonable choice for gaining an acceptable work space of allowed positional orientations for workpiece object 2′ in view of the various apparatus geometrical and force imparting device constraints encountered in the alternative arrangements available for manipulator 1.

A succeeding truncated cylinder, 4″, in the stack, and having the second largest outer diameter in the stack, provides an outer surface that is a ball bearing support surface. This truncated cylinder forms a collar about the post axis of symmetry with respect to a final truncated cylindrical shell, 4′″, having the smallest outer diameter and providing a resolver hollow shaft mating surface as will described below. Outermost truncated cylindrical shell 4″′ extends from the outer side of the collar formed by truncated cylinder 4″ to an outer end of fork base post 4 and has an end surface there that extends perpendicular to the cylindrical length of this post. A threaded circular opening extends into post base 4′ from the end thereof accessible through mounting screw recess 3^{vi}, and a screw, 4^{iv}, is inserted through this recess into the threaded opening in this post base to secure fork base post 4 to base ring 3. A threaded circular opening also extends into outermost truncated cylindrical shell 4″′ through the end surface thereof.

A fork arc structure, 5, has the two ends of the arc across from each other so that two circular output structure engagement openings, 5′ and 5″, each extending through the arc structure at a corresponding one of those ends, have a common axis of symmetry. A third opening, a fork base engagement opening, 5′″, extends through the arc structure at the center thereof approximately equidistant from each of output structure engagement openings 5′ and 5″ about an axis of symmetry that perpendicularly intersects the common axis of symmetry of those engagement openings. Fork base engagement opening 5″′ has an intermediate diameter portion extending inward from the outside of fork arc structure 5 to near the opposite side of that opening through fork arc structure 5, but with a smaller diameter opening extending a short further distance toward the opposite side to form an outside shoulder for the intermediated diameter opening. Thereafter, following the smaller diameter opening, a larger diameter opening extends the remaining distance to the opposite side, or the inside of fork arc structure 5, to thereby form an inside shoulder in fork base engagement opening 5″′ with respect to this larger diameter opening.

A pair of ball bearings, 6, are positioned in the smaller diameter portion of fork base engagement opening 5″′ against the outside shoulder and retained there by a pair of retaining screws, 6′, that are screwed into corresponding threaded openings in fork arc structure 5 on either side of that engagement opening. A spacer ring, 6″, is positioned about outermost truncated cylindrical shell 4′″, and against the collar provided with respect thereto by truncated cylinder 4″, and fork arc structure 5 is mounted on fork base post 4 such that ball bearings 6 are about the bearing surface of truncated cylinder 4″ of that fork base to thereby allow fork arc structure 5 to rotate about fork base 4 while suspended across from the open center surrounded by lower ring portion 3′ and upper ring portion 3″.

Against the inside shoulder formed in fork base engagement opening 5′″, and in the larger diameter portion of that opening, there is positioned a small portion of a brushless resolver, or rotary transformer, 7, a fork rotation measurement resolver, with the remaining portion thereof extending along the axis of symmetry of fork base engagement opening 5″′ and fork post 4 so as to be partly inside of fork arc structure 5. Resolver 7 has an outer case, 7′, with electrical windings within it and a groove, 7″, in and around the outside of it. Case 7′ surrounds a hollow shaft, 7′″, with electrical windings about it, and with this shaft being supported by case 7′ on bearings so that shaft 7′″ can rotate with respect to case 7′. These case and rotor electrical windings are connected to external resolver electrical leads, 7^{iv}, which are for connection to a suitable voltage source and to a suitable voltage measuring instrument. Case 7′ is the part of resolver 7 that is against the inside shoulder in fork base engagement opening 5′″, and is held there by a resilient resolver case retaining clip, 8, which is in turn fastened to fork arc structure 5 by a pair of screws, 8′, screwed into corresponding threaded openings. Thus, case 7′ rotates with fork arc structure 5.

Hollow shaft 7′″ is positioned about the hollow shaft mating surface of outermost truncated cylindrical shell 4′″ of fork base 4, and has a screw, 9, extending both within it and into the threaded opening extending through the end surface of outermost truncated cylindrical shell 4′′ and so into that shell parallel to its cylindrical length. Screw 9 holds shaft 7′″ in a fixed position with respect to fork base 4 so that rotations of fork arc structure 5 with respect to that fork base also rotate case 7′ with it about shaft 7′″. Rotations of output structure 2 about the common axis of symmetry of output structure engagement openings 5′ and 5″, to be described below, result in rotations of recessed relief channel 2^{iv} past the head of screw 9 that projects into that recess. If suitable sinusoidal voltage is applied to leads 7^{iv} extending from either of the case or shaft electrical windings, voltage measurements of the remaining ones of leads 7^{iv} extending from the other electrical winding will provide voltage value representations of the angular changes between case 7′ and shaft 7′″ due to such relative rotations between them.

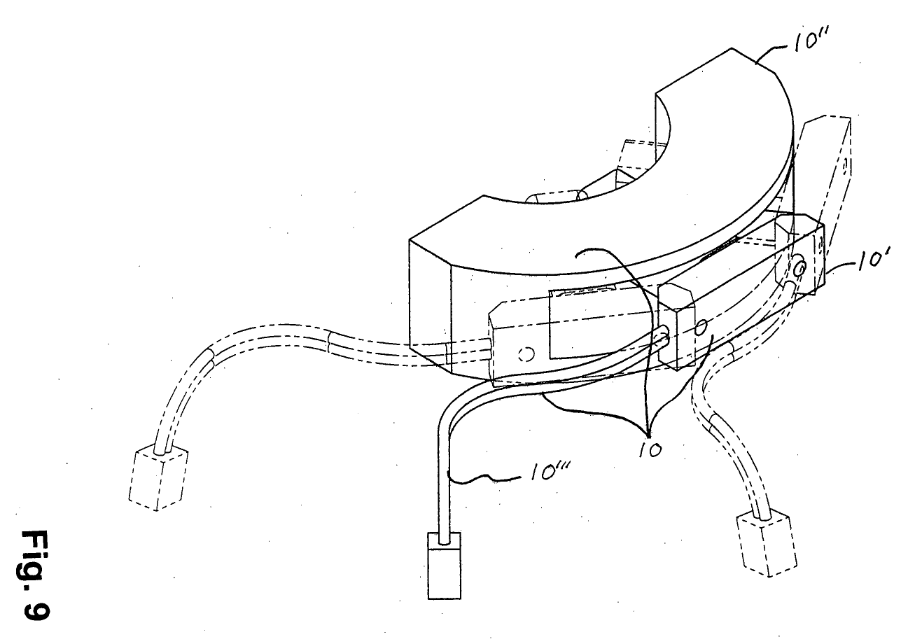

Rotations of fork arc structure 5 with respect to fork base 4, to thereby result in corresponding rotations of case 7′ about shaft 7′″ of resolver 7, are forced by a brushless sectional torque fork rotation motor, 10, shown in greater detail in three different motor rotation positions in FIG. 9. Fork rotation motor 10 provides torque consistently over a limited angular range using electrical currents selectively provided by a controller (not shown) in an electrical winding in a motor stator section, 10′, to thereby generate a magnetic field. This variable current generated field interacts with the magnetic field provided by a permanent magnet, 10″, serving in a motor rotor section, to thereby generate a corresponding torque. The direction of rotation is determined by the direction of electrical current provided through the electrical winding in motor stator section 10′ connected externally by electrical leads, 10′″.

A fork rotation motor shelf, 11, is affixed to lower ring portion 3′ at its horizontal bottom surface 3^{iv} in the middle one of the three plate mounting recesses 3^{v} therein by screws, 11′, that are screwed into corresponding threaded openings in base ring 3. This shelf is formed as a horizontal initial plate strip portion beginning near its mounting recess from where it extends inwardly into the open center within that lower ring portion along a ring portion radial direction to a joined canted strip portion thereof. This joined canted strip portion is canted upward from the horizontal initial strip portion at about a 45° cant angle. This canted strip portion has affixed thereto motor stator section 10′ of fork rotation motor 10 using a pair of screws, 12, that are screwed through the shelf into corresponding threaded holes in that motor stator.

Motor rotor section 10″ with the permanent magnet is affixed to fork arc structure 5 on the underside of that structure symmetrically about, but on the underside of, the axis of symmetry of fork base engagement opening 5′″ that perpendicularly intersects the common axis of symmetry of output structure engagement openings 5′ and 5″. Motor rotor section 10′ is affixed to fork arc structure 5 using a pair of screws, 12′, that extend through that arc structure and are screwed into corresponding threaded holes in this rotor section, and further using a pair of dowel pins, 12″, press fitted into dowel pin holes in the rotor section and positioned in corresponding dowel pins holes in the underside of fork arc structure 5.

Output structure 2 has arc structure 5 positioned with respect thereto such that the common axis of symmetry of output structure engagement openings 5′ and 5″ extends through support collar 2″ and the remainder of that output structure therein perpendicularly to minor flat side 2′″ of that output structure. A resolver and arc structure rotary support trunnion, 13, has a threaded stub, 13′, that is screwed into a threaded opening that extends through support collar 2″ and the remainder of output structure 2 therein along the common axis of symmetry of output structure engagement openings 5′ and 5″. Trunnion 13 is further formed of a stack of two concentric truncated cylinders with a truncated cylindrical shell on one end, all of differing outer diameters, that are joined end-to-end about an axis of symmetry. One of the truncated cylinders at one end of the stack, the one having the largest outer diameter, forms a base, 13″.

A succeeding truncated cylinder, 13′″, in the stack, and having the second largest outer diameter in the stack, provides an outer surface that is a roller bearing support surface. This truncated cylinder forms an inner shoulder about the trunnion axis of symmetry with respect to base 13″, and an outer shoulder with respect to an outer truncated cylindrical shell, 13^{iv}, having the smallest outer diameter. Outermost truncated cylinder 13^{iv} extends from the outer side of the collar formed by truncated cylinder 13′″ to an outer end of trunnion 13 and has an end surface that extends perpendicular to the cylindrical length of this trunnion. A threaded opening extends into outermost truncated cylindrical shell 13^{iv} through the end surface thereof.

Output structure engagement opening 5′, at one end of fork arc structure 5, has a small diameter opening portion of a relatively small diameter extending for a short distance from the inside of the arc structure toward the outside. Thereafter, an intermediate opening portion of a relatively intermediate diameter extends for much of the remaining distance toward the outside to thereby form an inside shoulder with respect to the small diameter opening portion. A large diameter opening portion of a relatively large diameter extends for the remaining distance toward the outside to thereby form an outside shoulder with respect to the intermediate diameter opening portion.

A ball bearing, 14, is positioned in the intermediate diameter portion of output structure engagement opening 5′ against the inside shoulder in that opening. Arc structure 5 is mounted on trunnion 13 such that ball bearing 14 is about the bearing surface of truncated cylinder 13′″ of that trunnion to thereby allow fork arc structure 5 to rotate about trunnion 13. A first spacer ring, 14′, is positioned about outermost truncated cylindrical shell 13^{iv}, and against the outside shoulder provided by the collar resulting from truncated cylinder 13′″, and also against ball bearing 14. A second spacer ring, 14″, is positioned about outermost truncated cylindrical shell 13^{iv}, and against the outside shoulder provided in output structure engagement opening 5′, and also against ball bearing 14.

Against spacer rings 14′ and 14″, and in the large diameter portion of output structure engagement opening 5′, there is positioned a small portion of another brushless resolver, 15, an output structure rotation measurement resolver, with the remaining portion thereof extending along the axis of symmetry of output structure engagement opening 5′ and trunnion 13 so as to be partly outside of fork arc structure 5. Resolver 15 is of the same type as resolver 7, and so has an outer case, 15′, with electrical windings within it and a groove, 15″, in and around the outside of it. Case 15′ surrounds a hollow shaft, 15′″, with electrical windings about it, and with this shaft being supported by case 15′ on bearings so that shaft 15′″ can rotate with respect to case 15′. These case and rotor electrical windings are connected to external resolver electrical leads, 15^{iv}, which are for connection to a suitable voltage source and to a suitable voltage measuring instrument.

Case 15′ is the part of resolver 15 that is against spacer rings 14′ and 14″ in the large diameter portion of output structure engagement opening 5′, and is held there by a resilient resolver case retaining clip, 16, which is in turn fastened to fork arc structure 5 by a pair of screws, 16′, screwed into corresponding threaded openings. Thus, case 15′ moves with fork arc structure 5.

Hollow shaft 15′″ has a screw, 17, extending through it into the threaded opening extending through the end surface of outermost truncated cylindrical shell 13^{iv} of trunnion 13 and into that shell parallel to its cylindrical length. Screw 17 holds shaft 15′″ in a fixed position with respect to trunnion 13 so that rotations of output structure 2, and so of trunnion 13, also rotate shaft 15′″ within case 15′. Thus, voltage measurements of the measurement ones of leads 15^{iv} will provide voltage value representations of the angular changes between shaft 15′″ and case 15′ due to such relative rotations between them.

Rotations of output structure 2 with respect to fork arc structure 5 are supported on the opposite side of this output structure by the other end of fork arc structure 5 having output structure engagement opening 5 extending through it. An arc structure rotary support trunnion, 18, has a threaded stub, 18′, that is screwed into a threaded opening that extends through support collar 2″ and the remainder of output structure 2 therein along the common axis of symmetry of output structure engagement openings 5′ and 5″. Trunnion 18 is further formed of a stack of two concentric truncated cylindrical shells, each of differing outer diameters, that are joined end-to-end about an axis of symmetry. One of the truncated cylindrical shells at one end of the stack, the one having the largest outer diameter, forms a base, 18″, and also forms a shoulder with respect to an outer truncated cylindrical shell, 18′″, because of having a smaller outer diameter for its outer surface that is a roller bearing support surface. Outermost truncated cylinder 13^{iv} extends from the outer side of the shoulder formed by truncated cylinder base 18″ to an outer end of trunnion 18 and has an end surface that extends perpendicular to the cylindrical length of this trunnion. A threaded opening extends into outermost truncated cylindrical shell 18′″ through the end surface thereof.

Output structure engagement opening 5″, at the remaining end of fork arc structure 5, has a small diameter opening portion of a relatively small diameter extending for a short distance from the inside of the arc structure toward the outside. Thereafter, a large diameter opening portion of a relatively large diameter extends for the remaining distance toward the outside to thereby form a shoulder with respect to the small diameter opening portion.

A ball bearing, 19, is positioned in the large diameter portion of output structure engagement opening 5″ against the shoulder in that opening. Arc structure 5 is mounted on trunnion 18 such that ball bearing 19 is about the bearing surface of outermost truncated cylindrical shell 18′″ of that trunnion to thereby allow fork arc structure 5 to rotate about trunnion 18. A bearing retainer ring, 19′, is positioned against bearing 19 and the end surface of outermost truncated cylindrical shell 18′″ and a retaining screw, 19″, is screwed through it into the threaded opening extending from that surface into shell 18′″.

Rotations of output structure 2 with respect to fork arc structure 5, to thereby result in corresponding rotations of shaft 15′″ within case 15′ of resolver 15, are forced by a brushless sectional torque output structure rotation motor, 20. Output structure rotation motor 20 is of the same type as fork rotation motor 10 as shown in FIG. 9, and so provides torque consistently over a limited angular range using electrical currents selectively provided by a controller (not shown) in an electrical winding in a motor stator section, 20′, to thereby generate a magnetic field. This variable current generated field interacts with the magnetic field provided by a permanent magnet, 20″, serving in a motor rotor section, to thereby generate a corresponding torque. The direction of rotation is determined by the direction of electrical current provided through the electrical winding in motor stator section 20′ connected externally by electrical leads, 20′″.

An output structure rotation motor shelf tab, 21, is formed as an integral part of fork arc structure 5 and extends inward in that arc structure from the side thereof having the end with output structure engagement opening 5″. This shelf tab is located in that structure about midway between output structure engagement opening 5″ and fork base engagement opening 5′″, and has a flat upper surface extending at an angle of about 60° from the direction followed by the side to which it is integral between those openings. This shelf tab flat upper surface has affixed thereto motor stator section 20′ of output structure rotation motor 20 using a pair of screws, 22, that are screwed through the shelf tab into corresponding threaded holes in that motor stator.

Motor rotor section 20″ with the permanent magnet is affixed to output structure 2 against minor flat side 2′″ thereof and on the underside of support collar 2″ where a portion has been omitted, but otherwise symmetrically about trunnion 18. Motor rotor section 20′ is affixed to the underside of support collar 2″ using a pair of screws, 22′, that extend through that collar structure and are screwed into corresponding threaded holes in this rotor section, and further using a pair of dowel pins, 22″, press fitted into dowel pin holes in the rotor section and positioned in corresponding dowel pins holes in the underside of the collar structure.

A partial support ring, 25, is positioned against the curved surface portion of output structure 2 following a hemisphere shape to support that output structure against vibration and shock during use. The partial support ring is formed in the shape generally of a slice of a hemisphere resulting from cutting two separated planes therethrough parallel to the flat surface thereof, and having a diameter at the inner surface of the slice equal to the diameter of the portion of outer surface in the output structure that follows a hemisphere shape, but with a part of that slice omitted. A separated, parallel outer surface of a greater diameter determines the thickness of the partial ring. A notch is provided in the upper side of ring 25 to accommodate a part of resolver 7 therein. The material, or materials forming the partial ring, are such the inner surface exhibits low friction when output 2 moves across it.

Partial support ring 25 is held in position against output structure 2 by three support posts, 26, 27 and 28. Each of support posts 26 and 27 is affixed to lower ring portion 3′ of base ring 3 at its horizontal bottom surface 3^{iv} in corresponding outer ones of the three plate mounting recesses 3^{v} therein by screws, 26′ and 27′, respectively, that are screwed into corresponding threaded openings in lower portion 3′ of base ring 3. Each of support posts 26 and 27 is formed as a horizontal initial plate strip portion beginning near its mounting recess from where it extends inwardly into the open center within that lower ring portion along a ring portion radial direction to a joined stem portion thereof. This stem portion extends vertically from there to an outward canted stem portion-having a threaded opening in the inward facing surface of this canted stem portion. This canted strip portion is canted outward from the vertical stem portion at about a 45° cant angle. These canted strip portions have affixed thereto partial support ring 25 using a pair of screws, 26″ and 27″, that are each screwed through a hole in the corresponding canted stem portion into a corresponding threaded opening in the ring portion.

Support post 28 has only a stem portion with an initial vertical part thereof affixed to base ring 3 in post mounting recess 3^{viii} by screws, 28′, that are screwed into corresponding threaded openings in base ring 3. The initial vertical part of support post 28 extends from near the recess vertically to an inward canted stem portion having a threaded opening in the inward facing surface of this canted stem portion. This canted strip portion is canted inward from the vertical stem portion at about a 45° cant angle. This canted strip portion also has affixed thereto partial support ring 25 using a screw, 28″, that is screwed through the hole in this canted stem portion into a corresponding threaded opening in the ring portion.

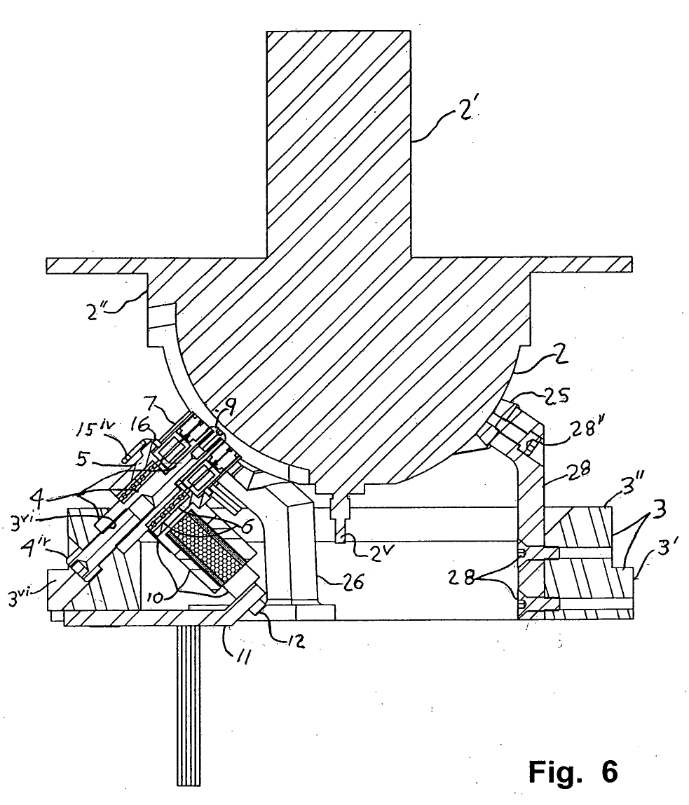

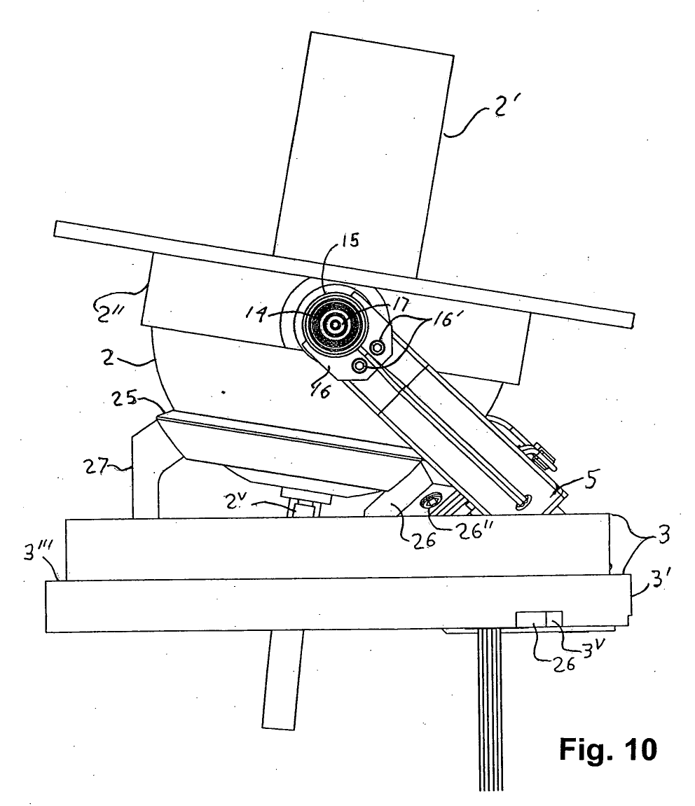

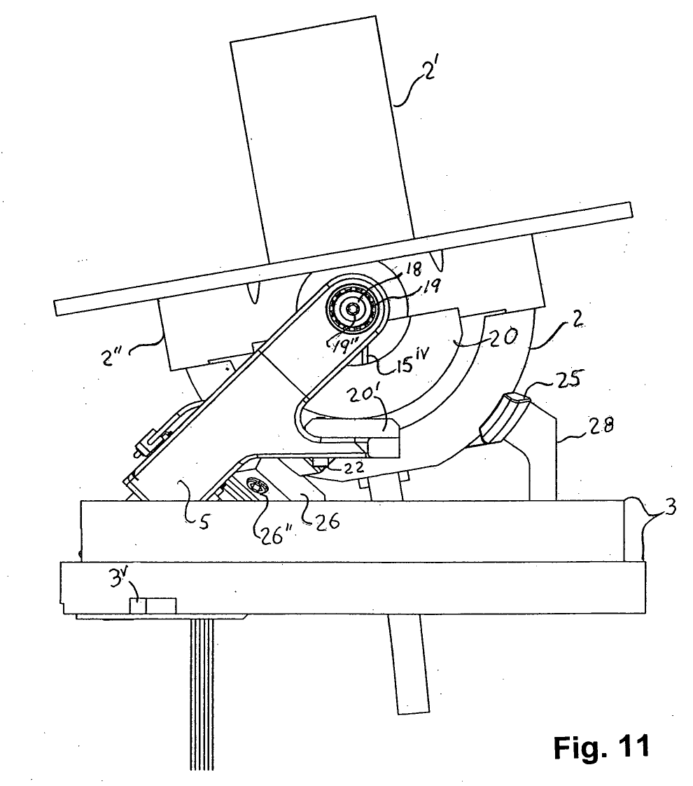

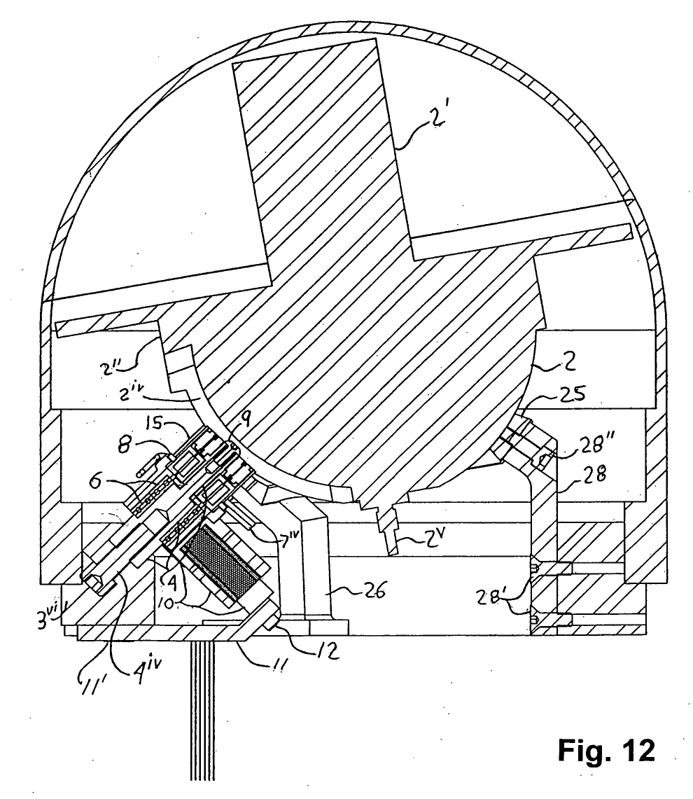

FIGS. 10 and 11 are both side elevation views of manipulator 1, but from opposite sides, and show that manipulator with workpiece object 2′ rotated from vertical toward the front, i.e. toward fork base 4. FIG. 10 shows manipulator 1 in elevation from the side of output structure 2 on which output structure rotation measurement resolver 15 is provided. FIG. 11 shows manipulator 1 in elevation from the other side of output structure 2 on which output structure rotation motor 20 is provided. FIG. 12 is a cross section view of manipulator 1 as it is shown in FIG. 11 taken along the same cross section plane as indicated in FIG. 4 for the cross section view shown in FIG. 6. Manipulator 1 in FIG. 12 is, in addition, shown housed in a dome affixed to base ring 3 which is of a material more or less transparent to the signal waves involved with whatever kind of sensor that is represented by workpiece object 2′.

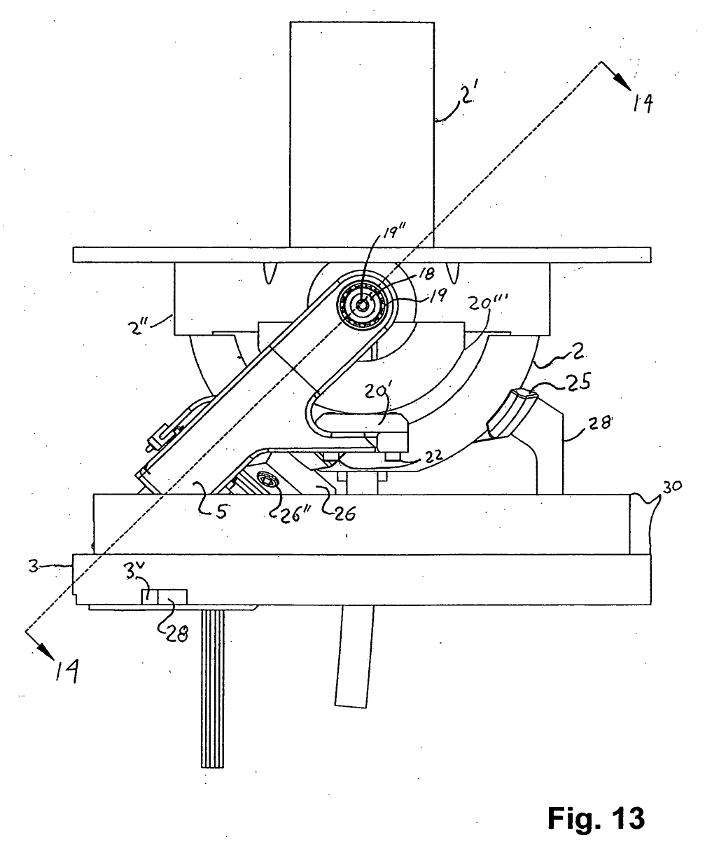

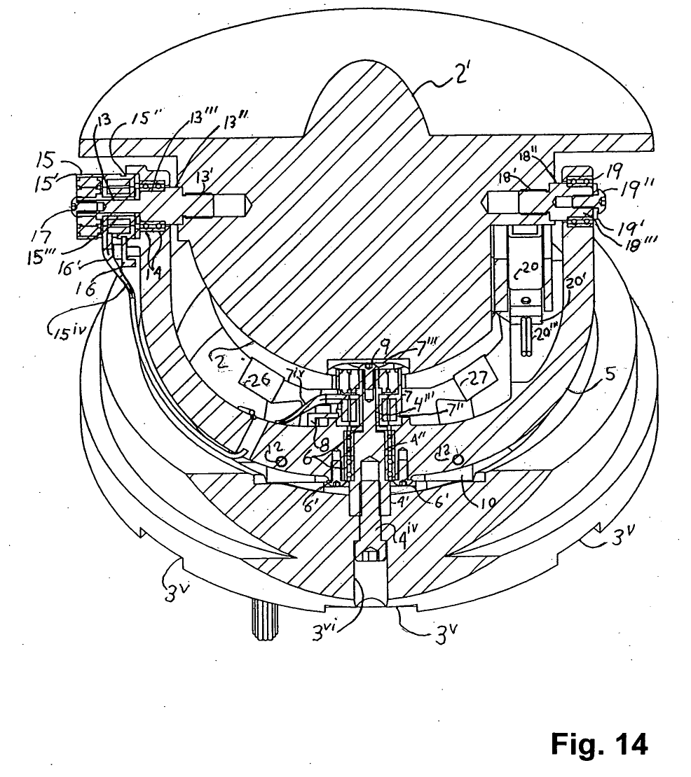

FIG. 13 shows manipulator 1 in elevation again from the side of output structure 2 on which output structure rotation motor 20 is provided, but with workpiece object 2′ vertical so as to be symmetrically positioned with respect to base ring 3 rather than rotated from the vertical toward the front. A cross section view of manipulator 1 is indicated in FIG. 13 to be shown in FIG. 14 that is taken along plane slated from front to back as indicated there. This slanted cross section shown positioned in FIG. 14 so as to show both resolvers 7 and 15 in cross section in the frontal perspective cross section view displayed there.

As can be seen in FIG. 7, electrical leads 15^{iv} of output structure rotation measurement resolver 15 are positioned from that resolver along the outside of fork arc structure 5 and then through an opening in that structure to be routed through the inside thereof and through the inside of base ring 3 to emerge downward from the bottom thereof. Similarly, electrical leads 20′″ of output structure rotation motor 20 are positioned from that motor to an connector mounted on fork arc structure 5 and the leads from the other side of that connector are also routed through the inside of that structure and through the inside of base ring 3 to emerge downward from the bottom thereof. They are joined in emerging downward from the bottom of base ring 3 by electrical leads 7^{iv} of fork rotation measurement resolver 7 and electrical leads 10′″ of fork rotation motor 10, leads that need not move during the operation of manipulator 1. However, electrical leads 15^{iv} and 20′″ of output structure rotation measurement resolver 15 and output structure rotation motor 20, in being at least somewhat affixed to fork arc structure 5, must rotate to some degree with that structure, and so must have some slack therein to allow them to flex with such arc structure rotations. Sufficient flexing can result in the risk of increased electrical lead failures.

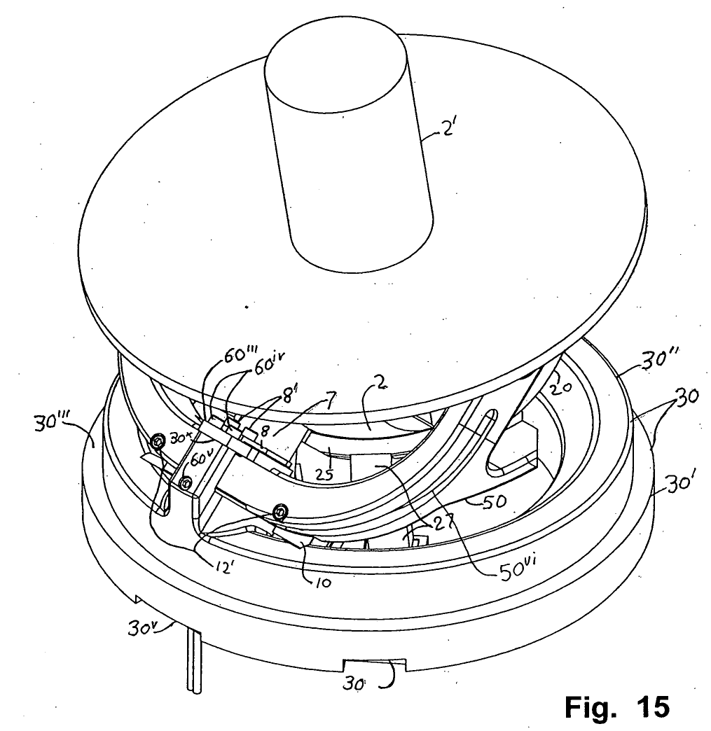

Such flexing of these leads can be avoided if, after being affixed to fork arc structure 5 in coming from resolver 15 and motor 20, they can be further positioned close to the axis of rotation of that arc structure to thereby change little in separation distance from base ring 3 during rotations of the arc structure. An alternative embodiment of manipulator 1 is shown in FIGS. 15, 16, 17 18 and 19A and B that provides such an arrangement for this alternative manipulator, 1′. This capability is provided through having, what was fork base post 4 affixed to base ring 3 about which arc structure 5 rotated, now become a fork post, having an open interior passageway, that is affixed to a modified arc structure and that can rotate within an opening in a modified base ring in which this fork post is inserted.

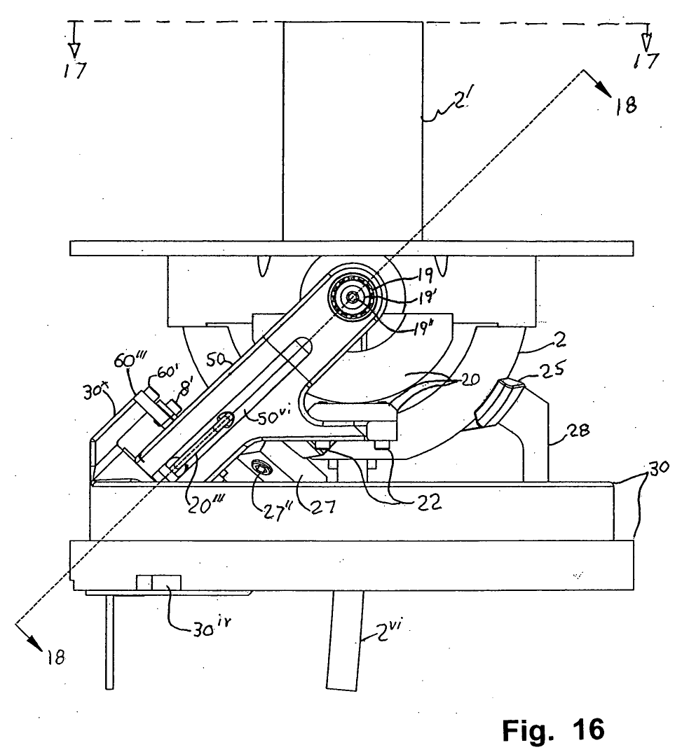

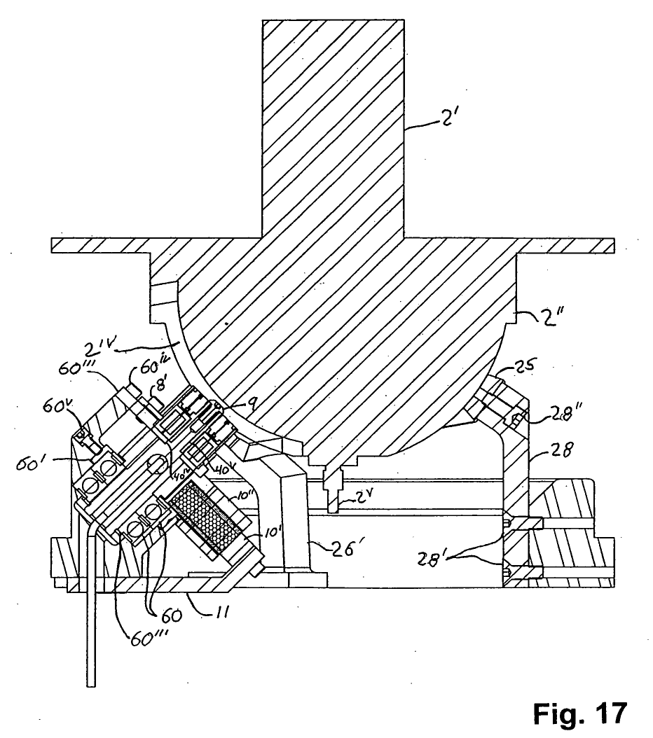

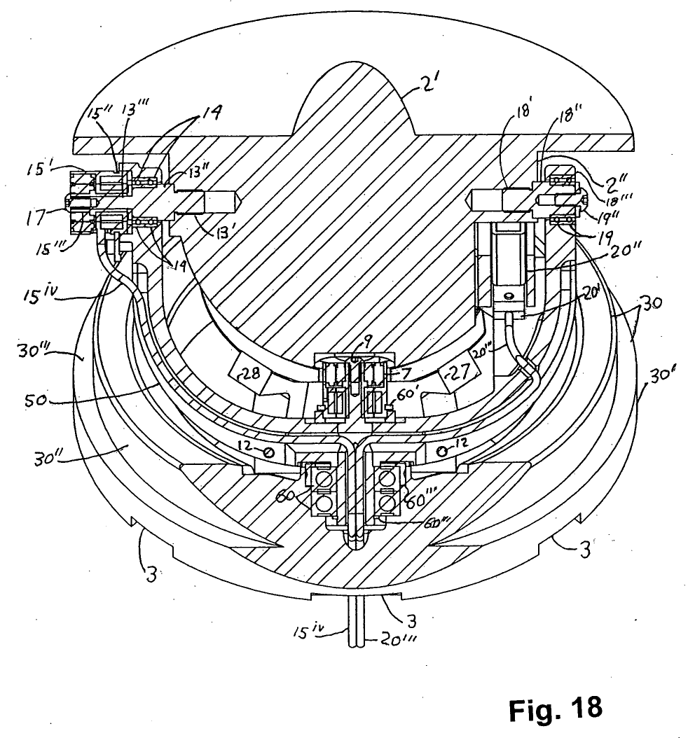

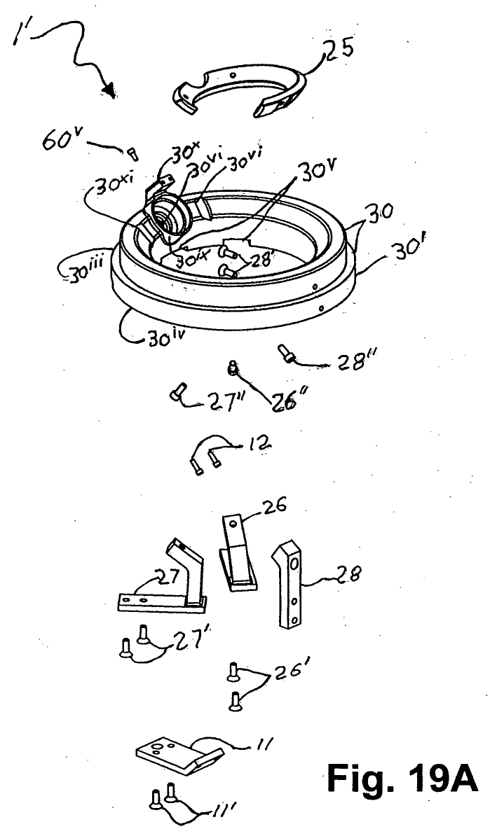

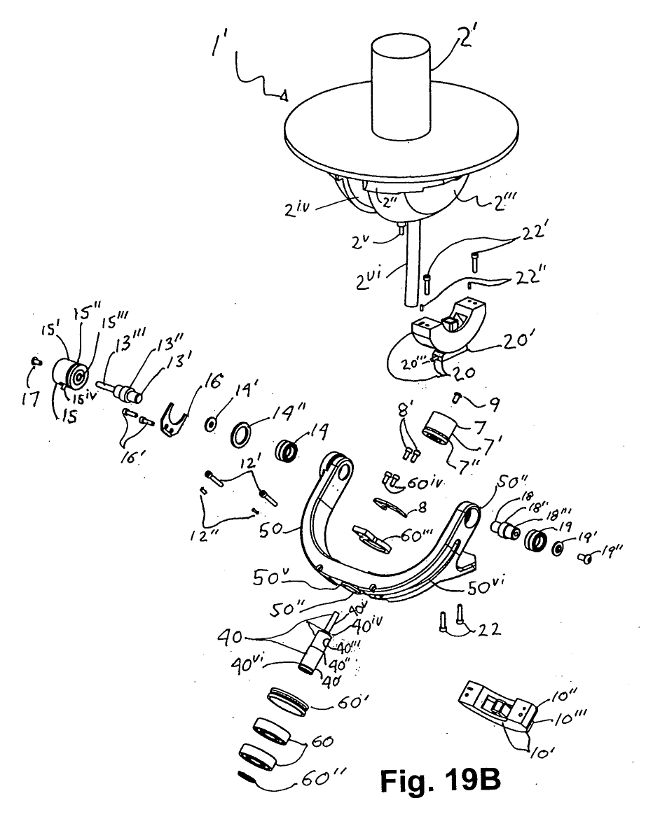

The object positioning arrangement, or alternative manipulator 1′, shown in the elevated perspective view of FIG. 15, corresponding to FIG. 1 for manipulator 1, again allows an object or workpiece to be rotated to various pointings about a single center point of rotation. A change in structure for alternative manipulator 1′, where fork base post 4 was affixed to base ring 3 for manipulator 1, is seen from the outside in this figure as it is in the side elevation view of FIG. 16 corresponding to FIG. 13 for manipulator 1. FIG. 16 has two cross section views indicated thereon which are seen in the side elevation cross section view shown in FIG. 17 that corresponds to FIG. 6 for manipulator 1, and in the slant cross section view shown in FIG. 18 that corresponds to FIG. 14 for manipulator 1. Finally, exploded views of alternative manipulator 1′ are shown in FIGS. 19A and 19B that correspond to FIG. 8 for manipulator 1. The same feature and component designations are used all figures for the same features and components being shown in those figures.

A base ring, 30, for manipulator 1′, modified from base ring 3 for manipulator 1, has again a lower ring portion, 30′, with an exterior side surface of a greater diameter than the exterior side surface of an upper ring portion, 30″, to thereby expose a horizontal top surface, 30′″, of the lower ring portion outside of where that ring portion is joined to the upper ring portion so as to thereby end the inward extent of surface 30′″. Horizontal top surface 30′″ of the lower ring portion, projected parallelly inward, again defines the joining plane of the upper and lower ring portions, and is positioned on the opposite side of lower ring portion 30′ from a horizontal bottom surface, 30^{iv}, of this lower ring portion, and from which three plate mounting recesses, 30^{v}, extend into this lower ring portion. A circular cross section electrical lead access opening, 30^{vi}, extends through the upper surface of the middle one of these three plate mounting recesses 30^{v} to extend vertically upward into this lower ring portion.

Lower ring portion 30′ again surrounds the open center with its interior side surface having a diameter that is the same as that of the interior side surface about this open center of upper ring portion 30″ into which it merges where these two ring portions are joined together at the joining plane. Again, the interior side surface about the open center of upper ring portion 30″, from a location above this joining location, is beveled outwardly at about 45° from vertical starting at that location, and from there that bevel extends to the top of that upper ring portion.

The final upward extent of electrical lead access opening 30^{vi} emerges into the center of a larger diameter hole mounting recess, 30^{vii}, with an axis of symmetry that extends partly inward in a direction toward the axis of symmetry of the base ring 30 open center, and so partly along a radius of that base ring, but at an angle of about 45° with respect to a horizontal plane. Hole mounting recess 30^{vii} extends into upper ring portion 30″ from the beveled interior surface thereof and into lower ring portion 30′ with a reduced diameter near the end of its innermost penetration into the base ring so as to provide a hole mounting recess inner collar there. In addition, hole mounting recess 30^{viii} is extended past the beveled surface of the upper ring portion through being surrounded outside of that upper ring portion by a truncated outer cylindrical shell wall, 30^{ix}, which wall extends outwardly and perpendicularly from the beveled surface of upper ring portion 30″. An anchor tab, 30^{x}, formed approximately as a slightly slope sided rectangular solid, extends in a direction parallel to the axis of symmetry of hole mounting recess 30^{vii} from the topmost portion of hole mounting recess outer cylindrical shell wall 30^{ix} with two end threaded openings extending into the inner end thereof parallel to its extent. An additional set screw threaded opening extends into anchor tab 30^{x} near its opposite end from the top thereof perpendicular to the direction of extent of the two threaded openings extending into the inner end thereof. Also, a pair of wire positioning ridges, 30^{xi}, is provided across the beveled surface of upper ring portion 30″ from past the bottom edge of that surface to past the top edges thereof, one pair member on each side of hole mounting recess outer cylindrical shell wall 30^{ix} near thereto.

A fork post, 40, having an open interior passageway, is formed of a stack of a pair of truncated cylindrical shells joined end-to-end concentrically on a side of a truncated cylinder joined end-to-end concentrically on the other side thereof with another truncated cylindrical shell, all of differing outer diameters. This pair of cylindrical shells, the truncated cylinder and the opposite cylindrical shell, are all joined together in end-to-end sequence concentrically about an axis of symmetry. One of the truncated cylindrical shells at one end of the stack, the one having the largest outer diameter, forms a post rotation ball bearing surface shell, 40′, that is positioned in ball bearings, to be described below, that are provided in hole mounting recess 30^{vii}, so that post rotation ball bearing surface shell 40′ extends through the interior beveled surface of upper ring portion 30″, and into that ring portion, at an angle of about 90° with respect to that surface.

As a result, the axis of symmetry of fork post 40 also extends partly inward in a direction toward the axis of symmetry of the open center, and so partly along a radius of base ring 30, but at an angle of about 45° with respect to a plane through horizontal top surface 30′″ of lower ring portion 30′. Again, this is not the only angle that could be chosen for fork post 40 but is a reasonable choice for gaining an acceptable work space of allowed positional orientations for workpiece object 2′ in view of the various apparatus geometrical and force imparting device constraints encountered in the alternative arrangements available for manipulator 1′. The exposed end of post ball bearing surface shell 40′ is open to the open interior thereof.

A succeeding passageway access truncated cylindrical shell, 40″, a member of the shell pair, is next in the stack and has the second largest outer diameter in that stack to thereby result in the larger diameter of post ball bearing surface shell 40′ forming a collar with respect thereto. Passageway access truncated cylindrical shell 40″ has its outer surface pierced by a pair of passageway access openings, 40′″, therethrough that extend into an interior passageway in fork post 40. This interior passageway is formed by the interior openings of concentrically joined pair of cylindrical shells 40′0 and 40″ to form a “T shaped” open passageway with circular arms in the “T” and extending from openings 40′″ in passageway access truncated cylindrical shell 40″ to the open end of post ball bearing surface shell 40′. Passageway access truncated cylindrical shell 40″ forms a collar about the fork post axis of symmetry with respect to the following offset truncated cylinder, 40^{iv}, having the next smallest outer diameter in the stack. Offset truncated cylinder 40^{iv} has a very small extent along the fork post axis of symmetry and is provided to accommodate a spacing ring, as is described below, in forming a collar about the fork post axis of symmetry with respect to a final or outermost truncated cylindrical shell, 40^{v}, in the stack that has the smallest outer diameter.

Outermost truncated cylindrical shell 40^{v} provides a resolver hollow shaft mating surface, as will be described below, and extends from the outer side of the collar formed by offset truncated cylinder 40^{iv} to an outer end of fork post 40 and has an end surface there that extends perpendicular to the cylindrical length of this post. A threaded circular opening extends into outermost truncated cylindrical shell 40^{v} through the end surface thereof. Also, a retaining ring groove, 40^{vi}, is provided circumferentially below and opening into the bearing surface of post rotation ball bearing surface shell 40′ near the end of fork post 40 opposite that having the end surface of outermost truncated cylindrical shell 40^{v}.

A fork arc structure, 50, has the two ends of the arc across from each other so that two circular output structure engagement openings, 50′ and 50″, each extending through the arc structure at a corresponding one of those ends, have a common axis of symmetry just as engagement openings 5′ and 5″ do in fork arc structure 5 and the same opening wall shapes. A third opening, a circular fork post engagement opening, 50′″, extends through the arc structure at the center thereof approximately equidistant from each of output structure engagement openings 50′ and 50″ about an axis of symmetry that again perpendicularly intersects the common axis of symmetry of those engagement openings. Fork base engagement opening 50′″ has an interior rectangular recess surrounding it on the inside of fork arc structure 50 and, from the bottom of this recess, this engagement opening extends through that arc structure to the outside thereof with a diameter slightly less than that of the outer surface of access truncated cylindrical shell 40″ in fork post 40. This hole is extended outward by a ring wall, 50^{v}, extending outward a relatively short distance from the arc structure outer surface.

A pair of grooves, 50^{vi}, in the outside surface of fork arc structure 50, and centered between the top and bottom of the structure outer surface, follow the contour of that surface with one of them extending from near output structure engagement opening 50′ to one side of fork post engagement opening 50′″. The other of grooves 50^{vi} extends from an opening, 50^{vii}, through fork arc structure 50 near output structure engagement opening 50″ to the other side of fork post engagement opening 50′″.

Fork post 40 is press fitted into fork post engagement opening 50′″ from the outside of fork arc structure 50 so that the outer surface of access truncated cylindrical shell 40″ in this fork post is mated to the sides of opening 50′″. The collar formed between post ball bearing surface shell 40′ and access truncated cylindrical shell 40″ has, as a result, ring wall 50^{v} of fork arc structure 50 positioned against it. In addition, each of grooves 50^{vi} meets a corresponding one of passageway access openings 40′″ in the outer surface of access truncated cylindrical shell 40″ so as to provide access from these grooves into the interior passageway in fork post 40.

A pair of ball bearings, 60, preceded by a retainer collar, 60′, formed as a planar ring with an internal ring extending perpendicularly thereto at the edge of the planar ring opening, are together concentrically one after the other slid onto post rotation ball bearing surface shell 40′ of fork post 40 as that post is affixed in fork arc structure 50. They are retained on fork post 40 by a retainer snap ring, 60″, positioned in retaining ring groove 40^{vi} in the bearing surface of post rotation ball bearing surface shell 40′. Fork post 40, as affixed in fork arc structure 50, with retainer collar 60′, ball bearings 60, and retainer snap ring 60″ thereon, is then positioned in hole mounting recess 30^{vii} of base ring 30, and against the hole mounting recess inner collar so that post ball bearing surface shell 40′ of that post is in that interior opening. The side of retainer collar 60′ is then positioned across from the set screw threaded opening in anchor tab 30^{x}, and the end of ring wall 50^{v} of arc structure 50 fits within the planar ring opening retainer collar 60′.

A tab extended ring, 60′″, is provided by a stepped ring structure so as to have tabbed ring shoulder therein that is formed of a ring structure portion of a relatively small opening diameter and a concentrically joined ring structure portion of a relatively larger opening diameter. A rectangular tab extends outward from the joined ring structure portions in the plane passing through where those portions are joined, this tab having a first pair of openings therethrough corresponding to the end threaded openings in the end of anchor tab 30^{x} of base ring 30. There is an adjacent second pair of openings through the rectangular tab which are threaded openings that correspond to the openings in resolver case retaining clip 8. Tab extended ring 60′″ is positioned about fork post 40 extending through the ring opening thereof, and retained there by a pair of retaining screws, 60^{iv}, that are screwed into the corresponding end threaded openings at the end of anchor tab 30^{x}. In addition, a set screw, 60^{v}, is screwed into the set screw threaded opening in anchor tab 30^{x} to be against the side of retainer collar 60′ to prevent that collar from sliding out of position.

Tab extended ring 60′″, in turn, retains ball bearing pair 60 and fork post 40, with fork arc structure 50 affixed thereto, in hole mounting recess 30^{vii} so as to allow fork post 40, with fork arc structure 50 affixed thereto, to rotate in ball bearing pair 60 with respect to base ring 30 while suspended across from the open center surrounded by lower ring portion 30′ and upper ring portion 30″. The opening at the end of post ball bearing surface shell 40′ in fork post 40 in this arrangement, one opening to the interior passageway of fork post 40, is then across from electrical lead access opening 30^{vi} where it emerges into the center of hole mounting recess 30^{vii} after extending vertically upward from middle plate mounting recess 30^{v} in lower ring portion 30′. Thus, the interior passageway in fork post 40 is effectively extended through base ring 30 to middle plate mounting recess 30^{v} in the lower ring portion thereof.

The remaining components in manipulator 1′ have the same designations in the figures pertaining thereto as they had in the figures pertaining to manipulator 1 as they are the same for both manipulators and are similarly assembled in each of those manipulators. Resolver 7, mounted on somewhat differing parts, has hollow shaft 7′″ positioned about the hollow shaft mating surface of outermost truncated cylindrical shell 40^{v} in fork post 40. Case 7′″ is the part of resolver 7 that is against the tabbed ring shoulder of tabbed ring 60′″, and is held there by resolver case retaining clip, 8, which is in turn fastened to tabbed ring 60′″ by a pair of screws, 8′, screwed into corresponding threaded openings in the rectangular tab. Thus, case 7′ is fixed in position with respect to base ring 30.

Screw 9 again extend both within hollow shaft 7′″ and into the threaded opening extending through the end surface of outermost truncated cylindrical shell 40^{v} and so into that shell parallel to its cylindrical length. Screw 9 holds shaft 7′″ in a fixed position with respect to fork post 40 so that rotations of fork arc structure 50 and that fork base in bearings 60 also rotate hollow shaft 7′″ with it. Rotations of output structure 2 about the common axis of symmetry of output structure engagement openings 50′ and 50″ again result in rotations of recessed relief channel 2^{iv} past the head of screw 9 that projects into that recess. All other components in manipulator 1′ mount and assemble as they were in manipulator 1.

The arrangement in manipulator 1′ allows resolver electrical leads 15^{iv} of output structure rotation measurement resolver 15 to be positioned in the nearest of grooves 50^{vi} and from there into the corresponding one of passageway access openings 40′″ in the outer surface of access truncated cylindrical shell 40″ of fork post 40 to pass through the interior passageway therein. Those leads can then pass from there through hole mounting recess 30^{vii} and electrical lead access opening 30^{vi} to emerge from middle plate mounting recess 30^{v} in lower ring portion 30′.

Similarly, the arrangement allows motor electrical leads 20′″ of output structure rotation motor 20 to be positioned through opening 50^{vii} in fork arc structure 50 near output structure engagement opening 50″, and then in the remaining one of grooves 50^{vi} to the remaining one of passageway access openings 40′″ in the outer surface of access truncated cylindrical shell 40″ of fork post 40. Those leads can then again pass through the interior passageway of fork post 40 and thereafter through hole mounting recess 30^{vii} and electrical lead access opening 30^{vi} to also emerge from middle plate mounting recess 30^{v} in lower ring portion 30′. Thus, rotation of fork arc structure 50 and affixed fork base 40 in bearings 60 about the rotational axis of symmetry thereof results in leads 15^{iv} and 20′″ rotating about that axis, but immediately adjacent thereto. Hence, such rotations will lead to relatively little movement of those leads in and out of electrical lead access opening 30^{vi} in middle plate mounting recess 30^{v} in lower ring portion 30′.

Although the present invention has been described with reference to preferred embodiments, workers skilled in the art will recognize that changes may be made in form and detail without departing from the spirit and scope of the invention.

1. A controlled relative motion system permitting a controlled motion member, joined to a base member, to selectively move with respect to said base member, said system comprising:
a base support substantially extending along a base plane,
an output structure,
a fork arc structure having a pair of arc output ends, each at an end of a corresponding one of a pair of arc arms, positioned across from one another with said output structure rotatably connected on opposite sides thereof to a corresponding one of said pair of arc arms adjacent said arc output end thereof so as to be rotatable about an output structure rotation axis intersecting each of said pair of arc arms adjacent said arc output end thereof,
a fork arc structure rotary support to which each remaining base end of said pair of arc arms, opposite said arc output end thereof, is joined, said fork arc structure support being rotatably connected to said base support so that said fork arc structure is rotatable about a fork axis extending substantially perpendicular to a arc structure plane that includes said output structure rotation axis and intersecting said base plane at a selected suspension angle,
an output structure force imparting means having a stator portion connected to a selected one of said output structure and a operating one of said pair of arc arms, and further having a rotor portion, selectively rotatable with respect to said stator portion thereof, connected to that one remaining of said output structure and said operating one of said pair of arc arms, and
a fork arc structure force imparting means having a stator portion connected to a selected one of said base support and said fork arc structure, and further having a rotor portion, selectively rotatable with respect to said stator portion thereof, connected to that one remaining of said base support and said fork arc structure.

2. The system of claim 1 wherein said base support has enclosure walls surrounding an operational opening in said base plane such that said base plane intersects said enclosure walls.

3. The system of claim 2 wherein there is an upright axis perpendicular to said base plane that passes through said operational opening and intersects said output structure.

4. The system of claim 1 wherein each of said base ends of said pair of arc arms are each formed ending with two side structures about a portion of an arc base opening with those side structures of each arc arm on a common side of mated said portions of said arc base opening being joined together to form a complete arc base opening, and with said arc structure rotary support being provided in said complete arc base opening and selected from a bearing assembly and a bushing.

5. The system of claim 4 wherein said base support has a pin structure on one side thereof extending along said fork axis which fork axis also crosses over an opposite side of said base support, said arc structure rotary support being positioned about said pin structure.

6. The system of claim 5 further comprising a brushless angle resolver having a shaft about which an outer case can rotate, said shaft connected to said pin structure and said case connected to said fork arc structure.

7. The system of claim 5 wherein said base support has enclosure walls surrounding an operational opening in said base plane such that said base plane intersects said enclosure walls, wherein there is an upright axis perpendicular to said base plane that passes through said operational opening and intersects said output structure.

8. The system of claim 1 wherein each of said base ends of said pair of arc arms are joined together, and with said fork arc structure having a pin structure extending from one side thereof at a location between said arc output ends, said pin structure extending in a direction at least in part away from said arc output ends.

9. The system of claim 8 wherein said base ends of said pair of arc arms are each formed ending with two side structures about a portion of an arc base opening with those side structures of each arc arm on a common side of mated said portions of said arc base opening being joined together to form a complete arc base opening, said pin structure extending from said complete arc base opening.

10. The system of claim 8 wherein said base support has a base suspension opening on one side thereof with a suspension plane intersecting sides of said base suspension opening, said suspension plane being perpendicular to said fork axis which fork axis also crosses over an opposite side of said base support, said arc structure rotary support being provided in said base suspension opening and selected from a bearing assembly and a bushing, said arc structure rotary support being positioned about said pin structure.

11. The system of claim 10 further comprising a brushless angle resolver having a shaft about which an outer case can rotate, said shaft connected to said pin structure and said case connected to said base support.

12. The system of claim 10 wherein said base support has enclosure walls surrounding an operational opening in said base plane such that said base plane intersects said enclosure walls, wherein there is an upright axis perpendicular to said base plane that passes through said operational opening and intersects said output structure.

13. The system of claim 1 wherein said output structure force imparting means is a sectional torque electric motor.

14. The system of claim 1 wherein said fork arc structure force imparting means is a sectional torque electric motor.

15. The system of claim 1 further comprising a support standard connected to said base support on one end and having an opposite holding a partial support ring having a ring outer surface positioned against said output structure with ring outer surface shaped to substantially match that shape of an outer surface of said output structure in an area thereof near said support ring.

16. The system of claim 1 wherein said suspension angle is approximately 45°.
